(19) United States
(12) Patent Application Publication
(10) Pub. No.: US 2007/0252038 A1
(43) Pub. Date: Nov. 1, 2007

(54) Aerial Security and Control System

(76) Inventor: Domiciano Santiago Alvarez, Quebradillas, PR (US)

Correspondence Address: ROBERTO J. RIOS, 256 ELEANOR ROOSVELT, SAN JUAN, PR, 00918, US

(21) Appl. No.: 11/306,090

(22) Filed: Dec. 15, 2005

(51) Int. Cl. B64D 9/00

(52) U.S. Cl. 244/118.1

(57) ABSTRACT

A security system for monitoring and securing an aircraft carrying passengers comprising an electronically remotely controlled lock to selectively lock an overhead storage compartment during the duration of a flight. A video/audio surveillance system is also provided along with a remote transmission and reception system. Access control to the pilot's cabin is also provided by the security system.

### FIELD OF THE INVENTION

This invention relates generally to anti-hijacking security and control systems, more specifically to method and systems for controlling access to a pilot's cabin and a cabin luggage compartment by providing a remotely controlled lock arrangement selectively actuated by a crew member inside the airplane's cockpit.

### BACKGROUND OF THE INVENTION

Security measures in airports like metal detectors, x-rayed luggage inspection and random passenger checks have increase since the terrorist attacks on Sep. 11, 2001. However, more security measures need to b a implemented board commercial aircrafts other than placing secret federal air marshals among the passengers. Even though, access to the pilot's cabin is usually controlled by the crew members, it is possible for a single person or a small group of individuals to hijack and take control of an aircraft by gaining access to the pilot's cabin area since access to said pilot's cabin is prevented only by a single door. Moreover, even if access to the pilot's cabin is prevented a possible hijacker or terrorist could potentially be carrying explosive material inside a carry-on bag or luggage which he/she could access anytime during the duration of the flight. Thus, what is needed is an internal security and control system to secure an aircraft and its passengers.

### SUMMARY OF THE INVENTION

Briefly stated, the invention comprises a security system for monitoring and securing an aircraft carrying passengers, said aircraft having flight crew members and a pilot, wherein said aircraft has a pilot cabin and a main passenger cabin, the security system comprising at least one luggage storage compartment including an electrically controlled lock, a central control unit connected to said electrically controlled lock and being remotely located from said luggage storage compartment. The security system may have an identity validation device connected to at least one of: a first access control input device, a second access control input device, and said central control unit; a lock arrangement connected to at least one of: the first access control input device, the second access control input device, said central control unit, and said identity validation device, wherein said lock arrangement selectively locks a pilot's cabin door based at least on one of: an identity validation device output signal, a first access control input device output signal, a second access control input device output signal, a central control unit output signal, and a luggage storage compartment status signal; an access control arrangement substantially separating the main passenger cabin from at least one of: a pilot's cabin area, a lavatory area, a storage area and a crew working area, wherein said access control arrangement is selectively actuated to either prevent or allow the free movement of passengers inside the aircraft when at least one of: a pilot's cabin door is opened, a pilot's cabin door is closed, a luggage storage compartment is opened, a luggage storage compartment is closed, and a central control unit generates an access control signal.

Preferably, a central video/audio unit is connected to a video/audio monitoring unit that receives video and audio signals from at least one video/audio camera, both units being located inside a pilot's cabin, and further comprising a transmitting/receiving unit connected to said central video/audio unit to selectively establish bidirectional communication between said aircraft and a remote land location.

### BRIEF DESCRIPTION OF THE DRAWINGS

Further features and advantages of the invention will become apparent from the following detailed description taken in conjunction with the accompanying figures showing illustrative embodiments of the invention, in which:

FIG. 1 shows an aircraft including the security system in accordance with the present invention.

FIG. 2 shows an aircraft including the security system in accordance with a second embodiment of the present invention.

FIG. 3 shows an inside view of a passenger cabin including the security system in accordance with the present invention.

FIG. 4 shows an aircraft including the security system in accordance with another aspect of the present invention.

FIG. 5 shows a diagram illustrating the components of the security system in accordance with the present invention.

FIG. 6 shows a partial view of an aircraft including the security system in accordance with another aspect of the present invention.

Throughout the figures, the same reference numbers and characters, unless otherwise stated, are used to denote like elements, components, portions or features of the illustrated embodiments. The subject invention will be described in detail in conjunction with the accompanying figures, in view of the illustrative embodiments.

### DETAILED DESCRIPTION OF THE INVENTION

Although the disclosure hereof is detailed and exact to enable those skilled in the art to practice the invention, the physical embodiments herein disclosed merely exemplify the invention which may be embodied in other specific structure. It is clear that changes and modifications to the described embodiments can be made without departing from the scope and spirit of the present invention as defined by the appended claims.

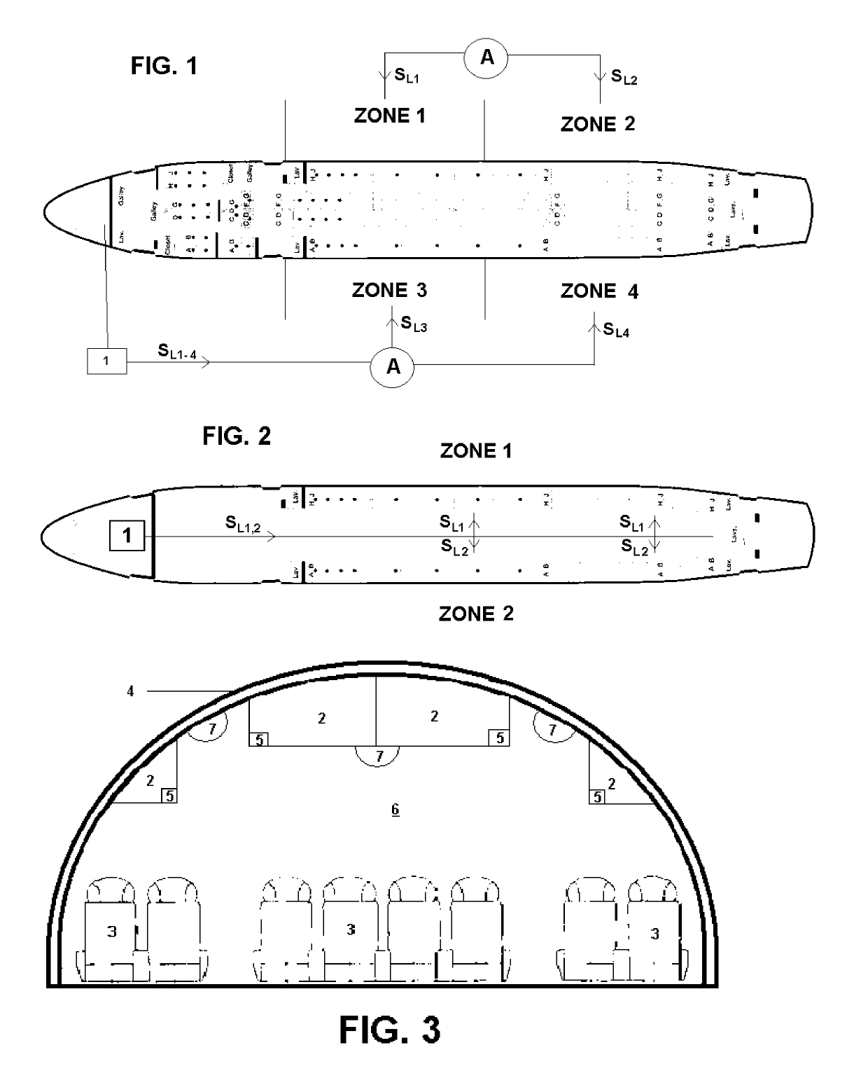

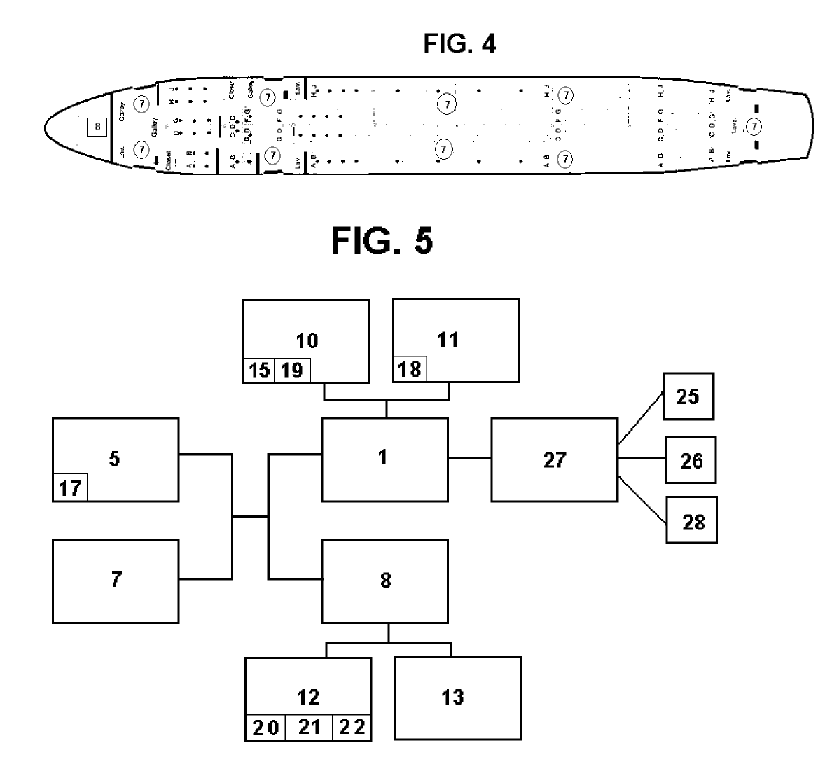

FIGS. 1-3 show the preferred embodiment of the invention. The security system is implemented primarily in 4 zones within the aircraft's passenger cabin (i.e., zones 1-4). A central control unit 1 is remotely located from the passenger's cabin to remotely control the security system. Preferably, this central control device is located inside the pilot's cabin. This location is preferred because there are security and access control measures already implemented by the FAA. Moreover, it will be the pilot's responsibility to ensure adequate security inside the aircraft. However, the central control unit 1 could also be located in a secure location inside the passenger's cabin, where only authorized crew members could have access. It is also envisioned to implement the security system by way of any wired or wireless control arrangement. In the preferred embodiment, the signals are sent by a data/control wire installed throughout the entire aircraft. Moreover, the control signals could be sent through the existing aircrafts data/control wires or alternatively with the appropriate modifications, through the aircraft's power wires by way of a “data over power line” scheme. Alternatively, the signals could be sent by any known wireless transmitting means (RF, IR, etc. . . . ), and remotely received by any known wireless receiving means (RF, IR, etc. . . . ).

The central control unit 1 sends at least one control signal S_{L} to security locks 5, which are remotely located throughout the entire passenger's cabin 6. In the preferred embodiment, central control unit 1 sends 4 control signals S_{L1}-S_{L4} to zones 1-4, respectively. The controlled zones 1-4 are established by symmetrically dividing the zones among the entire length and width of the aircraft based on its seating arrangement, as shown in FIG. 1. Alternatively, the controlled zones could be establish by the width of the aircraft based on its the seating arrangement as shown in FIG. 2. The security locks 5 are used to control access to the aircraft's overhead bins 2 located substantially above passenger's seats 3 as shown in FIG. 3. Regardless of the zone arrangement, the pilot or an authorized crew member would actuate a switching unit 10 to selectively lock/unlock the security locks. This switching arrangement 10 comprises of at least one user actuated switch 15 representing at least on controllable zone. Switch 15 is preferably a push button switch, but any user actuated switch could be alternatively used. In the preferred embodiment the security locks 5 are operated in group of zones. In other words, when the captain actuates the switch representing zone 1, all the security locks inside zone 1 will be opened or closed accordingly. However, it is also possible to operate individual security locks 5. Input means 19 could be provided so that the pilot or the authorized crew member enters an identifier for example 27-B (i.e., row 27, seat B) for the specific overhead bin 2. As an alternative, at least some of the security locks 5 could be actuated sequentially and/or with a time delay. Security lock 5 could be implemented as an electromechanic switch, magnetic switch, electrostatic switch or any other equivalent electrically controlled switch, which are well known in the art.

The operation of the embodiments described above will be explained in detail with reference to FIGS. 1-3.

When the passengers board the aircraft, they will be required to store their carry-on luggage inside the overhead bins 2 and proceed to seat in their assigned seats 3. Before takeoff, the appropriate crew members will make sure that there is no carry-on luggage under the seats or on possession of any passenger. Once this is confirmed, the appropriate crew members will make sure that all the overhead bins 2 are securely closed and will proceed to inform the pilot or any other authorized crew member. The pilot or any other authorized crew member who have access to the switching unit 10 will actuate at least one switch 15 to operate the security locks 5 and the lock the overhead bins 2. In the preferred embodiment of the invention, the overhead bins 2 remain closed and locked until the aircraft has arrived to its final destination. However, if a passenger needs to have access to an overhead bin 2 during the flight, the appropriate authorized crew members or the pilot will be notified so that the desired overhead bin 2 is securely unlocked and opened with the supervision of a crew member. After the passenger is done, the carry-on luggage will be stored again inside the overhead bin 2, which will closed and securely locked by the appropriate authorized crew member or the pilot.

In order to verify and monitor the status of the overhead bins 2, a monitoring unit 11 is provided as shown in FIG. 5. The monitoring unit 11 will proved constant real-time indication of the status of the overhead bins 2 and the security locks 5. Whenever an overhead bin 2 is opened, an open indicating signal will be generated. The monitoring unit 11 comprises of a user interface 18 to provide visual and/or audio indication of the status of said overhead bins 2 and security locks 5. It is envisioned that a visual display is provided along with an audio generating means to inform the pilot or an authorized crew member of any status change before, during and after the flight. The monitoring unit 11 also monitors the operating status of the security locks 5. If for any reason a normal operating status could not be obtained or verify from the security locks 5, the monitoring unit 11 will notify the pilot or an authorized crew member through any visual and/or audio means of a possible faulty or defective lock 5. In addition, a status indicating means could also be provided preferably under the overhead bins 2 along with the “seat-belts on” and “don't smoke” signs. That way, any crew member could notice a possible faulty or defective lock and take the appropriate corrective actions. Any well known fault detecting means that provides a status signal could be implemented to provide a fault-tolerant system.

Security lock 5 could be an additional lock means complementing the already installed locks of overhead bins 2. However, the already installed lock could be replaced by an integral security lock that will provide both a manual and a remote operation of the lock. It is also envisioned that a bypass unit 17 could be provided to allow opening of said overhead bin 2 in case there's a faulty or defective lock 5. The bypass unit could be in the form of a key/lock arrangement, a code/keypad arrangement or any other mechanism that would allow bypassing the security lock 5 control circuit.

In a second embodiment of the invention, a security video system is also implemented. A central video/audio unit 8 is provided inside the pilot's cabin to control and manage the security video system. Security cameras 7 are selectively located throughout the passenger's cabin to monitor any suspicious situation inside the cabin. Preferably, the location of said cameras is unknown to the passengers, however the cameras could also be positioned in locations visually accessible to the passengers to serve as an additional deterrent means to a possible hijacker or terrorist. A video/audio monitor unit 12 is provided to selectively control the cameras 7 and provide the received video and/or audio signals to the pilot or authorized crew member. A remote control mechanism 20 is provided to selectively control the movement and/or angle of view of said cameras 7. A visual display 21 is provided to show the received video image. An audio means 22 such as a speaker could also be provided so that the pilot or an authorized crew member could listen to any suspicious conversation. It is important to point out that this security video system is provided as a mechanism to prevent possible hijacking and suicidal attempts and should not be used to illegally invade the passenger's privacy.

A receiving/transmitting unit 13 is also provided to allow bidirectional communication between the aircraft and a land location while the aircraft is flying. The video/audio signals transmitted from the cameras 7 could be re-transmitted to a remote land location such as control tower or an airline's headquarter. That way, the pilot could receive further instructions on how to handle a possible hijacking or suicidal situation. In the preferred embodiment a satellite communication link is provided, however, the bidirectional communication could be implemented by any known wireless communication means that allow long distance links and doesn't interfere with the proper operation of the aircraft.

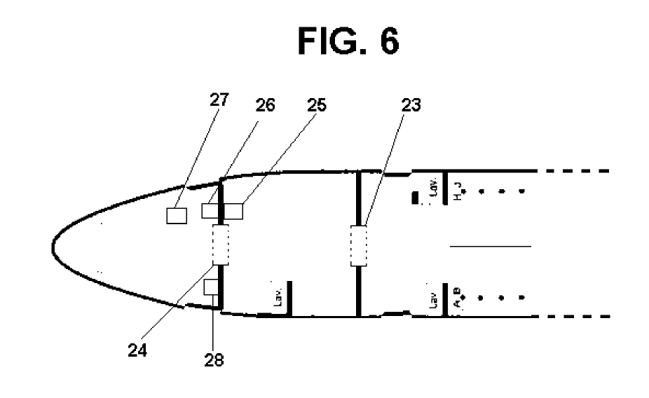

FIG. 6 shows another embodiment of the invention. In this embodiment, an access control arrangement 23 is provided to preclude anyone from having access to a pilot cabin's door 24 when a pilot or an authorized crew member inside said pilot's cabin needs to use the lavatory, thus opening pilot cabin's door 24 and creating a possible hijacking situation. Access control arrangement 23 could be closed/locked manually and/or automatically. Moreover, pilot cabin's door 24 is locked from inside the pilot's cabin. In practice, when the pilot or an authorized crew member inside said pilot's cabin needs to use the lavatory, he/she will open the door 24 and said door will be locked from inside said cabin. In addition, access control arrangement 23 is closed/locked substantially before or at the same time when said pilot cabin's door is open. After the pilot or the authorized crew member finishes using the lavatory, he/she would actuate external access control device 25 in order to allow access to said pilot's cabin. An internal access control device 26, to be actuated by a pilot or authorized crew member inside said cabin, is also provided to ensure a dual redundant-verification system. In the preferred embodiment, both access control devices 25 and 26 need to be actuated in order to open/unlock said door 24 by means of a lock arrangement 28 and regain access to said pilot's cabin. An identity validation device 27 is provided to receive outputs signals from at least but not limited to: said access control device 25, said access control device 26, and said central control unit 1 to verify the identity of any person trying to access the pilot's cabin. When an identity can't be verified, a pilot's cabin door is not opened/unlocked. Alternatively, an unverified identity status can also actuate other parts of the security system such as but not limited to: the overhead storage compartment locks 5, access control arrangement 23, video/audio monitor unit 12A, and receiving/transmitting unit 13. In addition, lock arrangement 28 could be selectively actuated from said central control unit 1 or based on the opened/closed status of the overhead storage compartment 2. For example, access to the pilot's cabin could be prevented while any overhead storage compartment 2 is opened. Moreover, access control devices could be implemented by way of a keypad/code arrangement, card reader, and biometric access control, among others. It should be clear that access control arrangement 23 could be controlled independently from said door 24 at any time before, during and after the flight. Access control arrangement 23 could be implemented as a door, a gate, a wall, a curtain or any other equivalent passage control means.

Although certain preferred embodiments and methods have been disclosed herein, it will be apparent from the foregoing disclosure to those skilled in the art that variations and modifications of such embodiments and methods may be made without departing from the true spirit and scope of the invention. Accordingly, it is intended that the invention shall be limited only to the extent required by the appended claims and rules and principles of applicable law.

What is claimed is:

1. A security system for monitoring and securing an aircraft carrying passengers, said aircraft having flight crew members and a pilot, wherein said aircraft has a pilot cabin and a main passenger cabin, said security system comprising:
at least one luggage storage compartment including an electrically controlled lock,
a central control unit connected to said electrically controlled lock and being remotely located from said luggage storage compartment.

2. The security system of claim 1, wherein said central control unit is located inside a pilot's cabin.

3. The security system of claim 1, wherein said central control unit is located inside the passenger's cabin.

4. The security system of claim 1, wherein said at least one luggage storage compartment includes a manual compartment lock.

5. The system of claim 4, wherein said electrically controlled lock is integrated into said manual compartment lock.

6. The security system of claim 1, further comprising a bypass means connected to said electrically controlled lock.

7. The system of claim 1, further comprising a switching unit connected to said central control unit.

8. The system of claim 7, wherein said switching unit further comprises input means to selectively perform at least one of: actuate a single lock, actuate all the locks, actuate a group of locks.

9. The system of claim 8, wherein said input means is selected from a group including at least one on of: a keypad, a touch panel, a mechanical switch, a solid-state switch, and a voice-actuated interface.

10. The security system of claim 1, wherein said central control unit is connected to said electrically controlled lock by wire means.

11. The security system of claim 10, wherein signals to operate the electrically controlled lock are transmitted through an aircraft's power distribution line.

12. The security system of claim 1, wherein said central control unit is wirelessly connected to said electrically controlled lock.

13. The security system of claim 12, wherein said wireless connection is selected from the group including at least one of: RF, IR, WIFI, BLUETOOTH.

14. The security system of claim 1, wherein said central control unit further comprises a monitoring unit to monitor the operating status of said electrically controlled lock.

15. The security system of claim 14, further comprising at least one indicating means connected to at least one of: said monitoring unit, said central control unit, and said electrically controlled lock.

16. The security system of claim 1, wherein said electrically controlled lock further comprises at least one of: a mechanical lock, an electromechanical lock, a solid-state lock, a magnetic lock, and an electrostatic lock.

17. The security system of claim 1, further comprising at least one video/audio camera selectively located inside the passenger's cabin.

18. The security system of claim 17, further comprising a central video/audio unit connected to a video/audio monitoring unit that receives video and audio signals from said at least one video/audio camera, both units being located inside a pilot's cabin.

19. The security system of claim 18, further comprising a transmitting/receiving unit connected to said central video/audio unit to selectively establish bidirectional communication between said aircraft and a remote land location.

20. The security system of claim 19, wherein data, audio and video signals are bi-directionally communicated between the aircraft and said remote land location.

21. The security system of claim 1, further comprising a first access control input device located inside said pilot's cabin.

22. The security system of claim 21, further comprising a second access control input device located outside said pilot's cabin.

23. The security system of claim 22, further comprising an identity validation device connected to at least one of: the first access control input device, the second access control input device, and said central control unit.

24. The security system of claim 23, further comprising a lock arrangement connected to at least one of: the first access control input device, the second access control input device, said central control unit, and said identity validation device.

25. The security system of claim 24, wherein said lock arrangement selectively locks a pilot's cabin door based at least on one of: an identity validation device output signal, a first access control input device output signal, a second access control input device output signal, a central control unit output signal, and a luggage storage compartment status signal.

26. The security system of claim 1, further comprising an access control arrangement substantially separating the main passenger cabin from at least one of: a pilot's cabin area, a lavatory area, a storage area and a crew working area.

27. The security system of claim 26, wherein said access control arrangement is selectively actuated to either prevent or allow the free movement of passengers inside the aircraft when at least one of: a pilot's cabin door is opened, a pilot's cabin door is closed, a luggage storage compartment is opened, a luggage storage compartment is closed, and a central control unit generates an access control signal.

28. The security system of claim 27, wherein the access control arrangement further comprises at least one of: a door, a gate, a wall, and a curtain.
